(19) United States
(12) Patent Application Publication
(10) Pub. No.: US 2006/0078001 A1
(43) Pub. Date: Apr. 13, 2006

(54) Wireless local area network medium access control extensions for station power efficiency and resource management

(75) Inventors: Arty Chandra, Manhasset Hills, NY (US); Sudheer A. Grandhi, Mamaroneck, NY (US); Joseph S. Levy, Merrick, NY (US); Stephen E. Terry, Northport, NY (US); Eldad Zeira, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/237,233

(22) Filed: Sep. 28, 2005

Related U.S. Application Data
(60) Provisional application No. 60/616,993, filed on Oct. 8, 2004.
(60) Provisional application No. 60/617,004, filed on Oct. 8, 2004.

(51) Int. Cl. H04L 12/56

(52) U.S. Cl. 370/473; 370/394

(57) ABSTRACT

An aggregated medium access control (MAC) frame for use with multiple transmission rates in a wireless communication system includes an aggregated header; at least one MAC protocol data unit (MPDU), the MPDUs being grouped together in the frame by transmission rate of the MPDU; and a separating sequence between each rate group. The aggregated header includes a count field to indicate a number of rates that have been aggregated in the frame and an information group for each rate that has been aggregated in the frame.

### CROSS REFERENCE TO RELATED APPLICATIONS

This application claims the benefit of U.S. Provisional Application No. 60/616,993, filed on Oct. 8, 2004, and U.S. Provisional Application No. 60/617,004, filed Oct. 8, 2004, which are incorporated by reference as if fully set forth herein.

### FIELD OF THE INVENTION

The present invention relates generally to wireless local area networks (WLANs), and more particularly, to medium access control (MAC) extensions to provide power efficiency and high throughput for the WLAN and to manage resources in the WLAN.

### BACKGROUND

Aggregation of several MAC protocol data units (MPDUs) by a station (STA) for transmission in a single frame has the advantage of improving MAC system efficiency. The efficiency results from a reduction in overhead due to fewer headers and less interframe spacing. Aggregation of MPDUs with different rates has the advantage of reducing overhead due to fewer preambles. Aggregation is optional and is triggered under traffic conditions where it may provide efficiency and high throughput.

As shown in FIG. 1A, a MAC frame 100 consists of a MAC header 102, a MAC frame body 104, and a frame check sequence (FCS) 106. The FCS 106 for the entire MAC frame 100 is needed by the STA to determine if the received MAC frame 100 is correct or erroneous. Therefore, a receiving STA has to listen to the whole MAC frame 100 even if it is not the intended recipient.

FIG. 1B shows a full MAC header 102 in a MAC frame 100 containing several fields, including a frame control field 110, a duration/ID field 112, one or more address fields 114₁-114₄, a sequence control field 116, and a quality of service (QoS) control field 118. Given the high throughput requirements and new low rate periodic data applications in a WLAN, the MAC header 102 can be a source of significant overhead. For example, a MAC frame 100 with a short frame body 104 requires the same size header 102 as a frame 100 with a maximum length frame body 104.

Traffic Class-based contention periods may be introduced as an effective way to provide quality of service (QoS) in contention access-based WLANs. It is a simple extension of enhanced distributed coordination access (EDCA), where contention periods are explicitly allocated for different traffic classes and referred to as explicit contention periods (ECPs). The channel access in an ECP is based on EDCA for a given set of traffic classes. The ECPs are allocated and scheduled by a central coordinator which may be co-located with the access point (AP). The beginning of an ECP is indicated by an ECP-Start frame and the end of an ECP is indicated by an ECP-End frame or an ECP-End+ECP-Start frame when another ECP begins immediately thereafter.

### SUMMARY

An aggregated MAC header is used to provide information about the MPDUs following the header in the aggregated frame. The robustness of the aggregated MAC header may be improved by providing a cyclic redundancy check (CRC) for each group of STA information fields, so that errors in other parts of the header do not affect a single group. For multi-rate aggregation, a CRC for each rate information and STA information makes it independent of errors in other parts of the header and makes it more robust. Also, the offsets for the rate and STAs are given instead of MPDU lengths so that the receiving STA does not have to read other parts of the aggregated header to determine where its MPDUs occur in the aggregated frame.

The present invention includes a reservation-based frame aggregation method which allows efficient multiplexing of MPDUs for several STAs within an aggregated frame. This type of fast multiplexing within an aggregated frame increases in efficiency when MAC header compression is also included.

An aggregated MAC frame for use with multiple transmission rates in a wireless communication system includes an aggregated header; at least one MAC protocol data unit (MPDU), the MPDUs being grouped together in the frame by transmission rate of the MPDU; and a separating sequence between each rate group. The aggregated header includes a count field to indicate a number of rates that have been aggregated in the frame and an information group for each rate that has been aggregated in the frame.

A method for creating a compressed MAC frame header in a wireless communication system begins by associating a STA to an AP. A header compression identifier (HCID) is assigned to the STA by the AP and is sent from the AP to the STA. The STA requests association of the HCID with header information to be compressed. The association of the header information with the HCID is recorded by the AP, and the AP acknowledges the association to the STA.

A MAC frame for use in a wireless communication system includes a header, a header CRC, a frame body, and a frame check sequence. The header CRC permits a receiver to stop receiving a MAC frame if the header CRC indicates an error in the header, thereby creating power savings for the receiver.

A compressed MAC frame for use in a wireless communication system includes a compressed MAC header, a frame body, and a frame check sequence. The compressed MAC header includes a frame control field, a duration field, a header compression identifier field, a sequence control field, and a quality of service control field.

An aggregated MAC frame for use with single rate transmissions in a wireless communication system includes an aggregated header and at least one MAC protocol data unit (MPDU), the MPDUs being grouped together in the frame for transmission to a single station. The aggregated header includes a count field to indicate a number of stations that have been aggregated into the frame and an information group for each station that has been aggregated into the frame.

A method for traffic class-based contention in a wireless communication system having an AP and at least one STA begins by determining at the AP whether a traffic class has accessed a communications medium within a predetermined duration in a single explicit contention period (ECP). The AP sends an ECP-End frame for a traffic class that has not accessed the communications medium in the predetermined duration, whereby the AP effectively shortens the ECP.

A system for traffic class-based contention in a wireless communication system includes a contention free period (CFP), at least one explicit contention period (ECP), a point coordination function interframe space (PIFS), and an AP. The CFP includes a beacon and a CFP-End frame. Each ECP includes an ECP-Start frame and an ECP-End frame. The PIFS is located after the CFP and before a first ECP. The AP includes a detector configured to detect if a traffic class has accessed a communications medium during an ECP and a transmitter configured to transmit the ECP-End frame upon detecting that a traffic class has not accessed the communications medium during the ECP, whereby the AP effectively shortens the ECP.

### BRIEF DESCRIPTION OF THE DRAWINGS

A more detailed understanding of the invention may be had from the following description, given by way of example and to be understood in conjunction with the accompanying drawings, wherein:

FIG. 1A is a diagram of an existing MAC frame;

FIG. 1B is a diagram of an existing MAC frame with a full MAC header;

FIG. 2 is a diagram of a single rate aggregated MAC frame with a MAC aggregation header;

FIG. 3 is a diagram of a multi-rate aggregated MAC frame with a MAC aggregation header;

FIG. 4 is a flow diagram of a method for creating a compressed MAC header;

FIG. 5A is a diagram of a MAC frame with a compressed MAC header unique to an AP;

FIG. 5B is a diagram of a MAC frame with a compressed MAC header unique across multiple APs;

FIG. 6 is a diagram of a MAC frame with a CRC for the MAC header; and

FIG. 7 is a diagram showing the ending of an ECP by an AP for a traffic class when no access is detected.

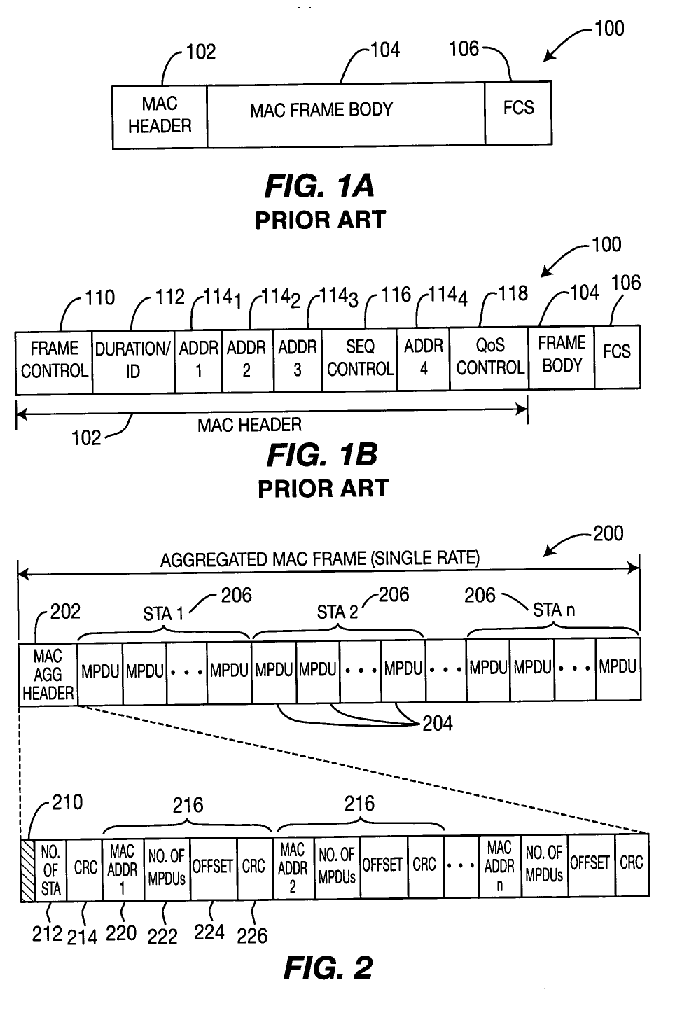

### DETAILED DESCRIPTION OF THE PREFERRED EMBODIMENTS

Aggregation with Header CRC Protection

FIG. 2 shows a diagram of an aggregated MAC frame 200 with transmissions at a single rate. The frame 200 includes an aggregated MAC header 202 and a plurality of MPDUs 204 which are grouped for each STA 206. The MPDUs 204 are grouped together based on the modulation and coding scheme (MCS) used.

The aggregated MAC header 202 includes one or more reserved fields 210; a number of STAs field 212, that contains the number of STAs that have been aggregated; a cyclic redundancy check (CRC) field 214, for the reserved fields 210 and the number of STAs field 212; and an entry 216 for each STA that has been aggregated. Each entry 216 includes the MAC address 220 of the destination STA, the number of MPDUs 222 for the destination STA, the offset 224 within the aggregated frame 200, and an optional CRC field 226. The offset 224 is relative to the beginning of the header 202 and is measured in units of time. This information is included so that the STAs may save power by going into sleep mode and waking up only to receive MPDUs intended for them.

The aggregated header 202 is used to provide information about the MPDUs 204 following the header in the aggregated frame 200. Based on the power save capability and service negotiation, the order in which STAs appear in the aggregated frame is determined. The service is negotiated at the time a STA associates with an AP with parameters that define the class of power saving device, the latency requirements, and other requirements. For example, a low latency requirement will mean that the data for that STA will appear earlier in the aggregated frame 200. Also for instance, the STAs that are in power save mode may be aggregated ahead of the other STAs, to allow maximum power savings for these STAs.

The robustness of the header 202 may be improved by providing a CRC 226 for each group of STA information fields 216, so that errors in other parts of the header 202 do not affect an individual group 216. The addition of the CRC 226 for the header information 216 allows the STA to verify the accuracy of the header information 216 before it uses power to receive the associated MPDUs 204. This reduces the likelihood that a STA will use power to receive an MPDU 204 not intended for it or that the STA will attempt to find an MPDU 204 at the wrong offset.

Group Reservation-Based Frame Aggregation

In large aggregation frames, the transmission of MPDUs may be included on the fly to groups of STAs; in other words, group reservation of resources (e.g., bandwidth or transmission medium time) for several STAs which may or may not have MPDUs addressed to them in the aggregation frame. When a STA associates with an AP, the STA is assigned to a group. The group membership may be changed at a later point in time by communication between the AP and the STA. A STA belonging to a given group listens to the transmission allocated for that group, during which time the STA may or may not have data addressed to it. In other words, a group of STAs shares the resources allocated to the group. This allows efficiencies arising from multiplexing within an aggregated frame. Including header compression further increases the efficiency of this mechanism.

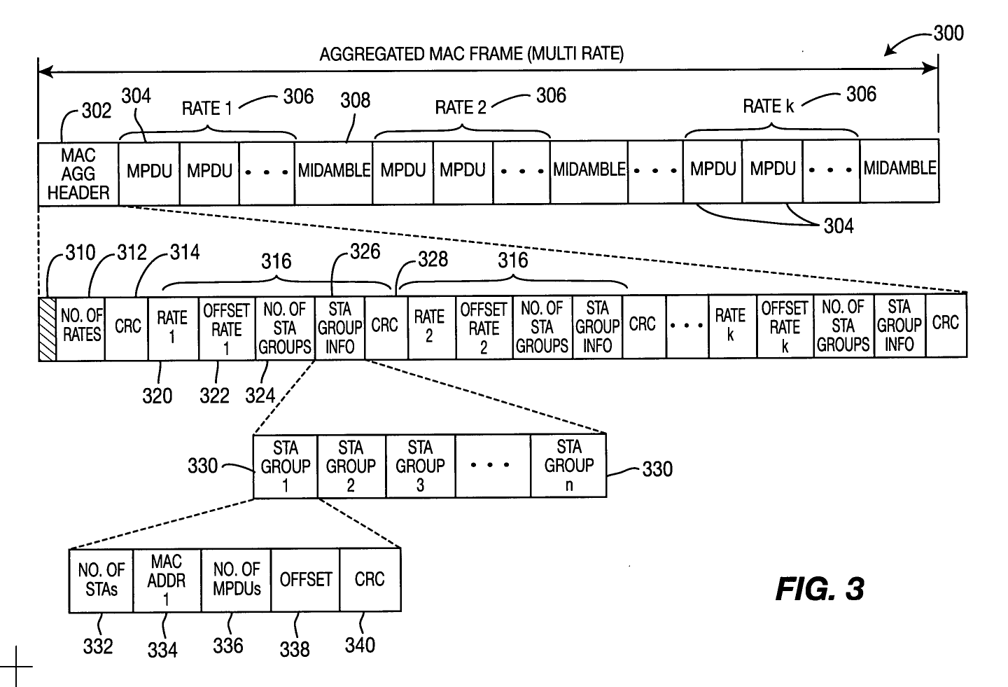

A multi-rate aggregated MAC frame 300 is shown in FIG. 3 and has an aggregation header 302 and a plurality of MPDUs 304 with multiple modulation and coding schemes (MCSs), which are arranged into groups 306 according to rate. The aggregation header 302 is used to provide information about the MPDUs 304 following the header in the aggregated frame 300. A midamble 308 is necessary between two different rate groups 306 for synchronization and channel estimation at the receiver.

While the present invention is described in terms of using a midamble to separate the rate groups, an embedded training sequence (ETS) may also be used. An ETS and a midamble are similar in that they are both used for synchronization and channel estimation. The midamble is used only when the rate changes, and has a fixed content and format. An ETS differs in that it can be used both when the rate changes and in a constant rate transmission. The ETS also allows STA-specific and channel-specific training fields. As an optional feature, an ETS can be strategically placed into an aggregated frame 300 to provide resynchronization opportunities to address clock drifts. There are several benefits to the resynchronization opportunity: allowing insertion of STA-specific and channel-specific training fields for each user; allowing the receiver and baseband to sleep, only waking up in time to be re-trained by the ETS; and relaxing clock and drift requirements.

Referring back to FIG. 3, when an aggregated frame 300 is large, it is efficient to assign durations in the aggregated frame to multiple receiving STAs or STA groups 306. The aggregation header 302 includes one or more reserved fields 310, a number of rates field 312, an optional CRC field 314 for the reserved fields 310 and the number of rates field 312, and an information group 316 for each MCS (rate). The information 316 includes the rate 320, the offset for the rate 322 within the aggregated frame 300, the number of STA groups 324, and STA group information 326 for each STA group 330. The size of the midamble 308 (or the ETS) should be accounted for in the corresponding offset value 322 in the aggregation header 302. Because the size of the midamble 308 is fixed and known, it can be accounted for in the offset value 322.

The STA group information 330 includes the number of STAs in the group 332, the MAC address of the group 334, the number of MPDUs to be sent to the group 336, and a group offset 338. The group offset 338 is relative to the header 302 and is expressed in units of time. A STA may use the rate offset 322 and STA group offset 338 together to save power by going into sleep mode and waking up only to receive MPDUs intended for its group.

The aggregation header 302 may be made robust by introducing a CRC 328 for each rate information group 316 and a CRC 340 for each STA group information 330.

The order in which STAs are aggregated is determined based on the power save capability of the STA and service negotiation. For instance, the STAs that are in power save mode may be aggregated ahead of the other STAs, enabling increased power savings. The group reservation-based frame aggregation scheme allows efficient multiplexing of MPDUs for several STAs within an aggregated frame. This type of fast multiplexing within an aggregated frame increases in efficiency when header compression is also included.

Header Compression

The MAC header can be compressed by replacing the MAC addresses with a Header Compression Identifier (HCID). The HCID is used to reconstruct the full headers for the compressed headers mapped to the HCID. The following procedures are needed to achieve header compression: creation of the HCID, assigning the HCID mapping between STAs, and inclusion of the HCID in the MAC header.

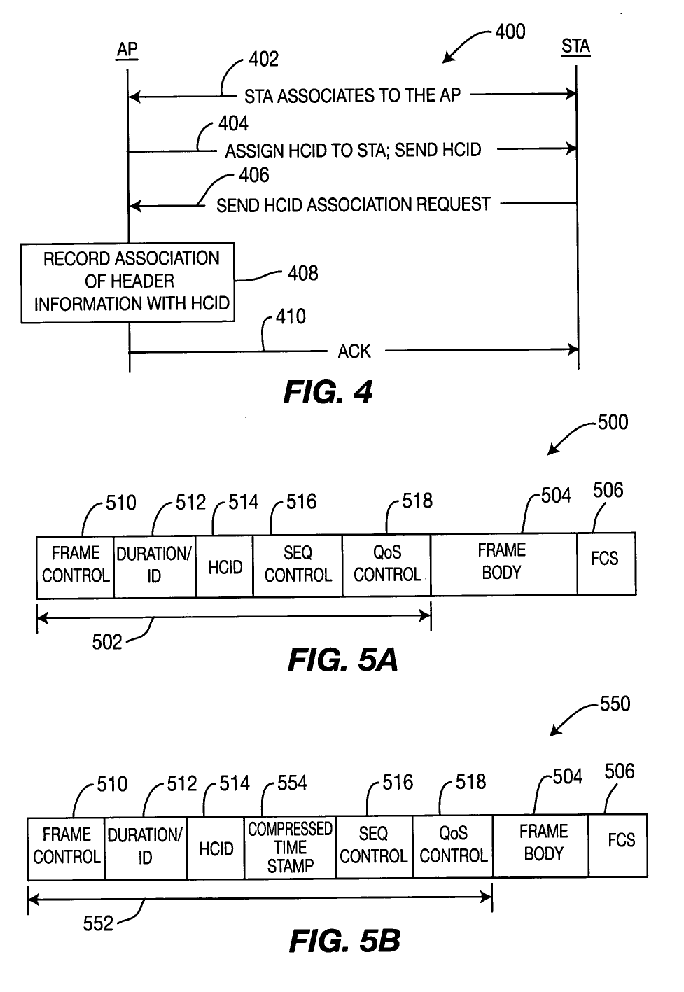

FIG. 4 is a flow diagram of a method 400 for creating a compressed MAC header. A STA becomes associated to an AP, per usual association procedures (step 402). The AP assigns an HCID to the STA and sends the HCID to the STA (step 404). An AP in the infrastructure mode assigns unique HCIDs to STAs that are associated to it. To utilize the HCID, the STA sends an HCID Association Request message to the AP (step 406). The HCID Association Request message includes the portions of the header needing compression (i.e., MAC addresses) and the HCID. The AP records the association of the header information with the HCID (step 408) and sends an acknowledgement (ACK) to the STA confirming that the association has been recorded (step 410). After this confirmation, the AP and the STA can exchange messages using the HCID. By compressing the MAC header with the HCID, the throughput of a WLAN system can be increased. An HCID can also be assigned to a STA group, instead of an individual STA.

FIG. 5A is a diagram of a MAC frame 500 with a compressed MAC header 502 that is unique to a single AP, a frame body 504, and a FCS 506. The compressed MAC header 502 includes a frame control field 510, a duration/ID field 512, an HCID 514, a sequence control field 516, and a QoS control field 518.

FIG. 5B is a diagram of a MAC frame 550 with a compressed MAC header 552 that is unique across multiple APs, a frame body 504, and a FCS 506. The compressed MAC header 552 includes a frame control field 510, a duration/ID field 512, an HCID 514, a compressed time stamp 554, a sequence control field 516, and a QoS control field 518.

When a non-AP STA is in the coverage area of two or more APs, there could be a duplication of HCIDs since each AP may assign the same HCIDs. To generate unique HCIDs across multiple APs, a compressed time stamp 554 of the association MPDU may be added to the unique HCID 514 of the AP. The association sequence number (i.e., the sequence number of the association MPDU) may be used in lieu of the compressed time stamp 554.

When operating in ad hoc mode, a similar method applies for header compression. A pair of initiating and target/responding STAs can create and manage a unique HCID which may not be unique across the system. However, a compressed time stamp 554 of the first frame from the transmitting STA may be added to the HCID 514 to create a unique identifier across the system.

When frame aggregation is used, the compressed time stamp 554 needs to be sent only in the first frame and the receiving STA associates the subsequent frames in the aggregate frame to the same AP. To increase robustness in the presence of errors, the compressed time stamp 554 may be sent more than once.

MAC Header CRC for Power Efficiency

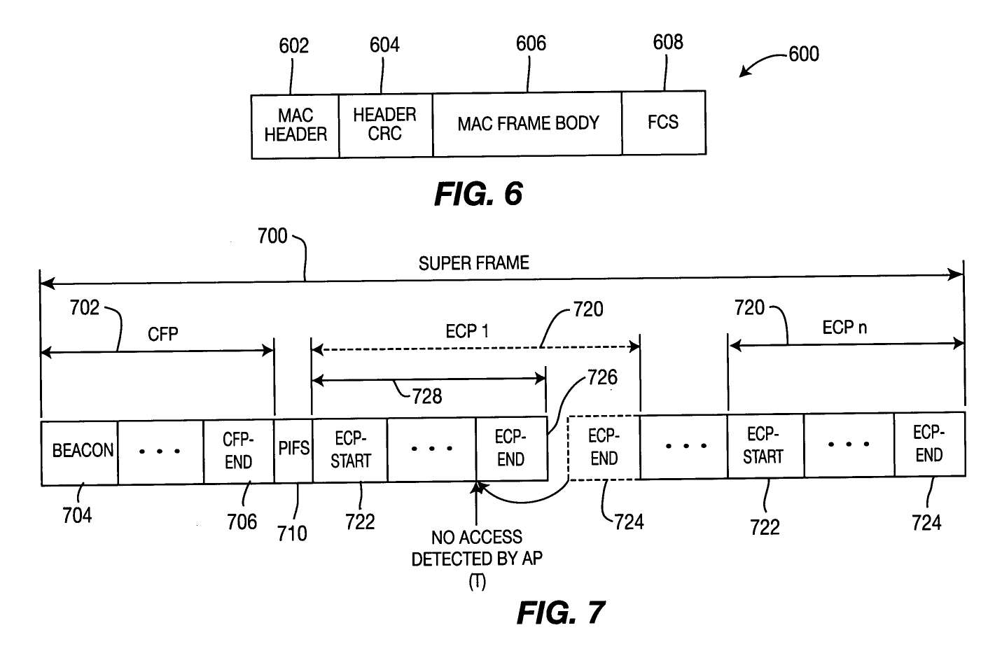

When the MAC frame is long, having a STA listen to the whole MAC frame may be a waste of battery power for the STA. A MAC frame 600 for power savings is shown in FIG. 6. The MAC frame 600 includes a MAC header 602, a header CRC 604, a frame body 606, and a FCS 608. The header CRC 604 is included so that a STA may wake up and read only the MAC header 602 and go back to sleep if the MAC frame 600 is not intended for that STA.

As the header CRC 604 is an additional overhead, it is best used when the MAC frame 600 is long enough and when there are a sufficient number of power saving devices in the system. To achieve this optimization, the following mechanisms may be used: (1) a length threshold that is configurable as a system parameter may be applied to determine if a header CRC 604 will be included in the MAC frame 600; and (2) the AP may announce by broadcasting that all MAC frames 600 shall support the header CRC 604, in scenarios where high throughput transmissions and power saving devices are predominant.

Since the header CRC 604 enables reading a MAC header 602 alone with error checking, it allows a STA to go into power saving mode (sleep) when packets are not addressed to it. Even if the implementation allows checking the MAC header 602 without using the FCS 608, the robustness of reading the MAC header 602 is increased and power saving benefits may be derived from it.

Smart Receiver for Power Efficiency

A receiver only receives a MAC frame if it is the intended recipient as indicated in the MAC header. If a STA is not the intended recipient, the STA will read only the MAC header and will enter into a power saving mode (i.e., go to sleep) for the remaining time indicated in the packet header. The remaining time is provided by the duration/ID field 112 in the frame header 102.

If there is an error in the header and the intended recipient STA information is wrong, there is no harm in having the STA discard the packet since there is no method for retrieving the correct recipient STA information. If there is an error in the time duration of the MAC frame (not a likely occurrence), then the STA will either be in the power saving mode for too long or too short a time. If the STA is in the power saving mode for too long a period, then there is a small chance that the STA will miss an MPDU intended for it. If the STA is in the power saving mode for too short a period, then the STA will turn back on too soon and will not derive the maximum benefit possible, which is not a significant impact to battery savings because the STA was in the power saving mode for most of the desired time period.

Class-Based Contention

Referring to FIG. 7, a super frame 700 includes a contention free period (CFP) 702 and at least one explicit contention period (ECP) 720. The CFP 702 includes a beacon 704 and a CFP-End frame 706. A point coordination function (PCF) interframe space (PIFS) 710 separates the CFP 702 from the first ECP 720. Each ECP 720 includes an ECP-Start frame 722 and an ECP-End frame 724.

During an ECP 720, the AP may detect no access for a given duration from one or more classes that have permission for access during that ECP. In such situations (indicated by point T in FIG. 7), the AP may send ECP-End frames 726 for those classes that showed no access activity for a given duration, effectively shortening the ECP 720 to a shortened length 728. The duration of inactivity prior to sending the ECP-End frames 726 may be dependent on the traffic class and may be specified accordingly. Also, the ECP-End frames 724 can be specific to each class in an ECP and a common ECP-End frame for all classes in the ECP is used to end the ECP for all classes in the ECP. It is noted that changing the timing of the ECP-End frame 726 for one ECP does not effect the ECP-End frames 724 for other ECPs; each ECP is independent of the other.

When no access by a traffic class is detected by AP, the permission to contend for that class is withdrawn. Thus, the resources available for another class contending in the same ECP is increased. If there are no other classes contending in that period, the resources are used for other functions in the system. Thus, the present invention reduces the number of unused medium resources in the system.

Although the features and elements of the present invention are described in the preferred embodiments in particular combinations, each feature or element can be used alone (without the other features and elements of the preferred embodiments) or in various combinations with or without other features and elements of the present invention. While the present invention has been described in terms of preferred embodiments, other variations which are within the scope of the invention as outlined in the claims below will be apparent to those skilled in the art.

What is claimed is:

1. An aggregated medium access control (MAC) frame for use with multiple transmission rates in a wireless communication system, comprising:
an aggregated header;
at least one MAC protocol data unit (MPDU), said at least one MPDUs being grouped together in the frame by transmission rate of the MPDU; and
a separating sequence between each rate group.

2. The aggregated MAC frame according to claim 1, wherein said aggregated header includes:
a count field to indicate a number of rates that have been aggregated in the frame; and
an information group for each rate that has been aggregated in the frame.

3. The aggregated MAC frame according to claim 2, wherein said aggregated header further includes:
a cyclic redundancy check field for said count field.

4. The aggregated MAC frame according to claim 2, wherein said information group includes:
a rate field including a transmission rate for the group;
an offset to indicate the location of the MPDUs within the frame;
a field to indicate a number of station groups in the rate group; and
a station information group for each station group in the rate group.

5. The aggregated MAC frame according to claim 4, wherein said offset is expressed in units of time and is relative to the beginning of said aggregated header.

6. The aggregated MAC frame according to claim 4, wherein said station information group includes:
a second count field to indicate a number of stations in the group;
a MAC address of the group;
a field to indicate a number of MPDUs for the group; and
an offset to indicate the location of the MPDUs within the frame.

7. The aggregated MAC frame according to claim 6, wherein said offset is expressed in units of time and is relative to the beginning of said aggregated header.

8. The aggregated MAC frame according to claim 6, wherein said station information group further includes:
a cyclic redundancy check field for said station information group.

9. The aggregated MAC frame according to claim 4, wherein said information group further includes:
a cyclic redundancy check field for said information group.

10. The aggregated MAC frame according to claim 1, wherein said separating sequence is a midamble.

11. The aggregated MAC frame according to claim 1, wherein said separating sequence is an embedded training sequence.

12. The aggregated MAC frame according to claim 11, wherein said embedded training sequence includes station-specific training fields.

13. The aggregated MAC frame according to claim 11, wherein said embedded training sequence includes channel-specific training fields.

14. The aggregated MAC frame according to claim 11, wherein said embedded training sequence is positioned at other locations within the aggregated MAC frame to provide resynchronization opportunities.

15. A method for creating a compressed medium access control frame header in a wireless communication system, the method comprising the steps of:
associating a station (STA) to an access point (AP);
assigning a header compression identifier (HCID) to the STA by the AP;
sending the HCID from the AP to the STA;
requesting association of the HCID with header information to be compressed by the STA;
recording the association of the header information with the HCID by the AP; and
acknowledging the association by the AP.

16. A medium access control (MAC) frame for use in a wireless communication system, comprising:
a header;
a header cyclic redundancy check (CRC);
a frame body; and
a frame check sequence, wherein the header CRC permits a receiver to stop receiving a MAC frame if the header CRC indicates an error in the header, thereby creating power savings for the receiver.

17. A compressed medium access control (MAC) frame for use in a wireless communication system, comprising:
a compressed MAC header;
a frame body; and
a frame check sequence.

18. The MAC frame according to claim 17, wherein said compressed MAC header includes:
a frame control field;
a duration field;
a header compression identifier field;
a sequence control field; and
a quality of service control field.

19. The MAC frame according to claim 18, wherein said compressed MAC header further includes a compressed time stamp.

20. The MAC frame according to claim 18, wherein said compressed MAC header further includes a sequence number of an association MAC protocol data unit.

21. An aggregated medium access control (MAC) frame for use with single rate transmissions in a wireless communication system, comprising:
an aggregated header; and
at least one MAC protocol data unit (MPDU), said at least one MPDUs being grouped together in the frame for transmission to a single station.

22. The aggregated MAC frame according to claim 21, wherein said aggregated header includes:
a count field to indicate a number of stations that have been aggregated into the frame; and
an information group for each station that has been aggregated into the frame.

23. The aggregated MAC frame according to claim 22, wherein said aggregated header further includes:
a cyclic redundancy check field for said count field.

24. The aggregated MAC frame according to claim 22, wherein said information group includes:
a MAC address of a destination station;
a field to indicate a number of MPDUs to be transmitted to the destination station; and
an offset to indicate the location of the MPDUs within the frame.

25. The aggregated MAC frame according to claim 24, wherein said offset is expressed in units of time and is relative to the beginning of said aggregated header.

26. The aggregated MAC frame according to claim 24, wherein said information group further includes:
a cyclic redundancy check field for said information group.

27. A method for traffic class-based contention in a wireless communication system having an access point (AP) and at least one station, the method comprising the steps of:
determining at the AP whether a traffic class has accessed a communications medium within a predetermined duration in a single explicit contention period (ECP); and
sending an ECP-End frame by the AP for a traffic class that has not accessed the communications medium in the predetermined duration, whereby the AP effectively shortens the ECP.

28. A system for traffic class-based contention in a wireless communication system, comprising:
a contention free period (CFP), having a beacon and a CFP-End frame;
at least one explicit contention period (ECP), each ECP having an ECP-Start frame and an ECP-End frame;
a point coordination function interframe space after said CFP and before a first of said at least one ECPs; and
an access point (AP), having
a detector configured to detect if a traffic class has accessed a communications medium during an ECP; and
a transmitter configured to transmit the ECP-End frame upon detecting that a traffic class has not accessed the communications medium during the ECP, whereby the AP effectively shortens the ECP.
